(19) United States
(12) Patent Application Publication
(10) Pub. No.: US 2026/0227997 A1
(43) Pub. Date: Aug. 6, 2026

(54) SYSTEM AND METHODS FOR VERSION-CONTROLLED CONFIGURATIONS PROMOTION

(71) Applicant: FIDELITY INFORMATION SERVICES, LLC, Jacksonville, FL (US)

(72) Inventors: Amiya BUDHIA, Bengaluru (IN); Mohammed NAZAAR, Bengaluru (IN); Kavitha ANNAMALAI, Hosur (IN); Anu LATHA BALAKUMAR, Chennai (IN)

(73) Assignee: FIDELITY INFORMATION SERVICES, LLC, Jacksonville, FL (US)

(21) Appl. No.: 19/464,234

(22) Filed: Jan. 29, 2026

Related U.S. Application Data
(60) Provisional application No. 63/752,528, filed on Jan. 31, 2025.

(51) Int. Cl. G06F 8/71

(52) U.S. Cl. CPC G06F 8/71

(57) ABSTRACT

A system and method for version-controlled configurations promotion is disclosed. More particularly, a system to implement version control for configuration as code (CaC) for improved accuracy and speed, and reduction in human error in the creation of computer application products across multiple developers is disclosed. More particularly, a system to generate and use JavaScript object notation (JSON) for each of a plurality of entities in a product is disclosed. More particularly, a system for changing the JSON configurations and managing the changes as they are promoted up to the product through an improved version control workflow is disclosed.

### RELATED APPLICATIONS

This application claims priority to U.S. Provisional Patent Application No. 63/752,528, entitled “SYSTEM AND METHODS FOR VERSION-CONTROLLED CONFIGURATIONS PROMOTIONS,” filed on Jan. 31, 2025. The contents of that application is incorporated herein by reference in its entirety.

### FIELD

The present disclosure relates generally to data processing and improvements in application deployment.

### BACKGROUND

Configuration management involves handling the settings and configurations of software applications, development environments, or systems that a program interacts with. This may include managing variables, properties, and environmental settings that control how a program behaves or interfaces with other services, databases, or systems. Version control refers to keeping track of different versions of configurations to manage changes over time. As computer application products grow in complexity, with many people working to make and improve their functionality, version control becomes increasingly important. However, existing methods of version control are inefficient and may impede the accuracy and speed of development of computer application products.

As organizations increasingly rely on configurable digital products, the volume and frequency of configuration changes have expanded beyond the capabilities of conventional management tools. Manual configuration propagation across development, QA, pre-production, and production environments introduces inconsistencies and restricts scalability. Furthermore, conventional version-control mechanisms are not designed to track granular configuration changes, particularly when configurations span numerous product, pricing, and feature parameters. This misalignment can create challenges in regression validation, and coordination across teams. Consequently, there is a growing need for a configuration-as-code solution that represents configuration data in JSON structured formats, allowing for precise tracking, diffing, automation, and controlled promotion of configuration changes.

Traditional migration workflows do not scale efficiently across such environments, particularly when multiple teams update features, pricing rules, conditions, and service parameters concurrently. Without automated comparison, structured diffing, and controlled release tagging, organizations often struggle to maintain consistent configuration states across branches and environments. These issues are further amplified in regulatory industries where deviations between configuration snapshots can result in compliance violations. Therefore, scalable and automated configuration management techniques are needed to address these challenges.

### SUMMARY

Embodiments of the present disclosure provide a system and method for improving the accuracy, speed, and reducing potential human error of version control in the creation of computer application products.

The inventive systems and methods may comprise multiple embodiments. In some embodiments, a method and system of configuration as code (CaC) is disclosed. According to some embodiments, the CaC version control may manage configurations via JavaScript Object Notations (JSONs). According to some embodiments, the CaC version control may allow companies to overcome the limitations of traditional configuration management and embrace a more agile and secure future for their products.

In some embodiments, a method for version control for development of a product is disclosed. In some embodiments, the method may comprise: generating a JavaScript object notation (JSON) for each of a plurality of entities in the product; generating a plurality of configurations from each JSON; changing at least one configuration; generating the changed configuration as an artifact; applying the changed configuration; and promoting the changed configuration to the product.

In some embodiments, a method for applying a changed JSON configuration is disclosed. In some embodiments, the method may comprise: (a) adding the changed JSON configuration to a first environment; (b) reviewing changes within the changed JSON configuration with a source branch as the changed JSON configuration and a target branch as the first environment; (c) reviewing the changed JSON configuration in a comparison routine; (d) committing the changed JSON configuration to the target branch; (e) creating a pull request from the source branch to the target branch; (f) tagging the pull request once the changes have been merged; (g) checking the pull request for a merge conflict; and (h) operating in a first state when the merge conflict is present, wherein the first state comprises rebasing the source branch and re-executing the method from step (c).

In some embodiments, a system for promoting a changed JSON configuration is disclosed. In some embodiments, the system may comprise: a develop branch and a production branch, wherein the develop branch may be configured to: merge changes in the changed JSON configuration to create a snapshot; create a development tag which corresponds to the snapshot; and apply the changes to a development quality assurance branch. The development quality assurance branch may be configured to validate the changes and move the changes to a milestone branch. The milestone branch may be configured to: merge changes in the changed JSON configuration to create a pre-release; create an M-tag which corresponds to the pre-release; and apply the changes to a pre-production branch. The pre-production branch may be configured to validate the changes and move the changes to a master branch. The master branch may be configured to: merge changes in the changed JSON configuration to create a release version; and apply the changes to the production branch.

Embodiments including system, methods, and computer-readable media implementing the above embodiments are also disclosed herein.

The foregoing general description and the following detailed description are example and explanatory only and are not restrictive of the claims. Other advantages of the embodiments of the present disclosure will become apparent from the following description taken in conjunction with the accompanying drawings wherein are set forth, by way of illustration and example, certain embodiments of the present invention.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. The above and other aspects of the present disclosure will become more apparent from the description of exemplary embodiments, taken in conjunction with the accompanying drawings. In the drawings:

FIG. 1 illustrates CaC version control routine, consistent with embodiments of the present disclosure.

FIG. 2 illustrates a product information retrieval routine, consistent with embodiments of the present disclosure.

FIG. 3 illustrates a configuration application routine, consistent with embodiments of the present disclosure.

FIG. 4 illustrates a CaC version control application routine, consistent with embodiments of the present disclosure.

FIG. 5 illustrates a parallel CaC version control application routine, consistent with embodiments of the present disclosure.

FIG. 6 illustrates a configuration comparison routine, consistent with embodiments of the present disclosure.

FIG. 7 illustrates a version-controlled configuration promotion routine, consistent with embodiments of the present disclosure.

FIG. 8 illustrates a parallel version-controlled configuration promotion routine, consistent with embodiments of the present disclosure.

FIG. 9 illustrates a configuration change applier routine, consistent with embodiments of the present disclosure.

FIG. 10 illustrates a configuration change deployment architecture, consistent with embodiments of the present disclosure.

FIG. 11A illustrates a first portion of CaC version control business process flow, consistent with embodiments of the present disclosure.

FIG. 11B illustrates a second portion of CaC version control business process flow, consistent with embodiments of the present disclosure.

FIG. 12 illustrates a diagram of a computing device, consistent with embodiments of the present disclosure.

### DETAILED DESCRIPTION

Reference will now be made in detail to exemplary embodiments, some examples of which are shown in the accompanying drawings.

It is understood that while certain embodiments are discussed to facilitate understanding of various principles and aspects of this disclosure, the embodiments are not described in isolation and the descriptions are not necessarily mutually exclusive. Thus, it is contemplated and understood that described features of principles of any embodiment may be incorporated into other embodiments.

Exemplary disclosed embodiments include apparatus, systems, and methods for streamlining the configuration management process, thereby reducing operational risks, such as user error, and improving time-to-market for new products.

According to some embodiments of the present disclosure, a method and system of configuration as code (CaC) is disclosed. According to some embodiments, the CaC version control may manage configurations via JavaScript Object Notations (JSONs). According to some embodiments, the CaC version control may allow companies to overcome the limitations of traditional configuration management and embrace a more agile and secure future for their products.

According to some embodiments of the present disclosure, the CaC version control may provide improved scalability in adapting to a growing complexity of products without the need for extensive manual intervention. According to some embodiments of the present disclosure, the CaC version control may provide improved collaboration by facilitating better collaboration across development, operations, and compliance teams by using a common language and repository for configurations. According to some embodiments of the present disclosure, the CaC version control may provide improved downtime recovery by enabling easier rollback and recovery processes in the event of a configuration error or system failure, minimizing service disruption. According to some embodiments of the present disclosure, the CaC version control may provide improved traceability by providing version control for precise change tracking and application of configuration changes, thereby simplifying implementation modifications while maintaining system integrity. According to some embodiments of the present disclosure, the CaC version control may provide improved compliance and audit-readiness by ensuring configurations are in line with regulatory standards and ready for audits with minimal preparation.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

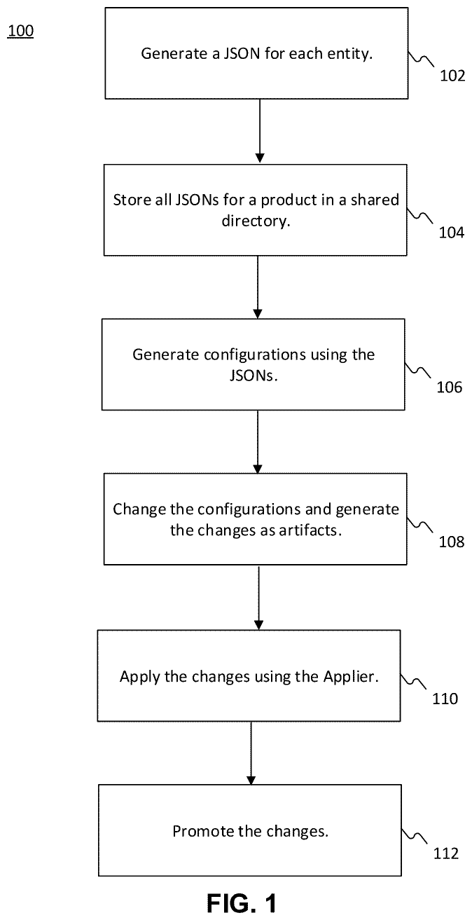

Reference is now made to FIG. 1, which illustrates CaC version control routine 100, consistent with embodiments of the present disclosure.

CaC version control routine 100 may include step 102, in which a human-readable logically segregated JSON is generated for each entity. According to some embodiments, an entity may comprise, for example, every role or condition in the product. According to some embodiments, a human-readable logically segregated JSON may refer to a JSON file that is structured in an organized way, which may include indentation and logical grouping of related data to enhance readability and understanding. Segregation and clear formatting may aid developers or users to interpret the data, modify it if needed, and identify key sections and relationships. According to some embodiments, the JSONs may be generated by a representational state transfer Application Programming Interface (rest API). According to some embodiments, rest API may refer to the architectural style for designing networked applications. According to some embodiments, a rest API may use stateless communication, where each request from a client to a server must contain all the necessary information to understand and process the request. According to some embodiments, the rest API may allow systems to communicate over HTTP by transferring state in a structured format, for example JSON or XML. According to some embodiments, the rest API may be simplified and require only the product code to generate the JSONs.

CaC version control routine 100 may include step 104, in which the JSONS may be stored in a common directory for the product. According to some embodiments, the directory may be named after the product.

CaC version control routine 100 may include step 106, in which the configurations are generated using the JSONs. According to some embodiments, the configuration data may represent data that defines the behavior of an application or system.

CaC version control routine 100 may include step 108, in which the user may make changes to the configurations. According to some embodiments, the changes will be generated as artifacts. According to some embodiments, the changes will be generated as version-controller artifacts.

CaC version control routine 100 may include step 110, in which the changes are applied to different environments using the Applier.

CaC version control routine 100 may include step 112, in which the changes are promoted to higher environments.

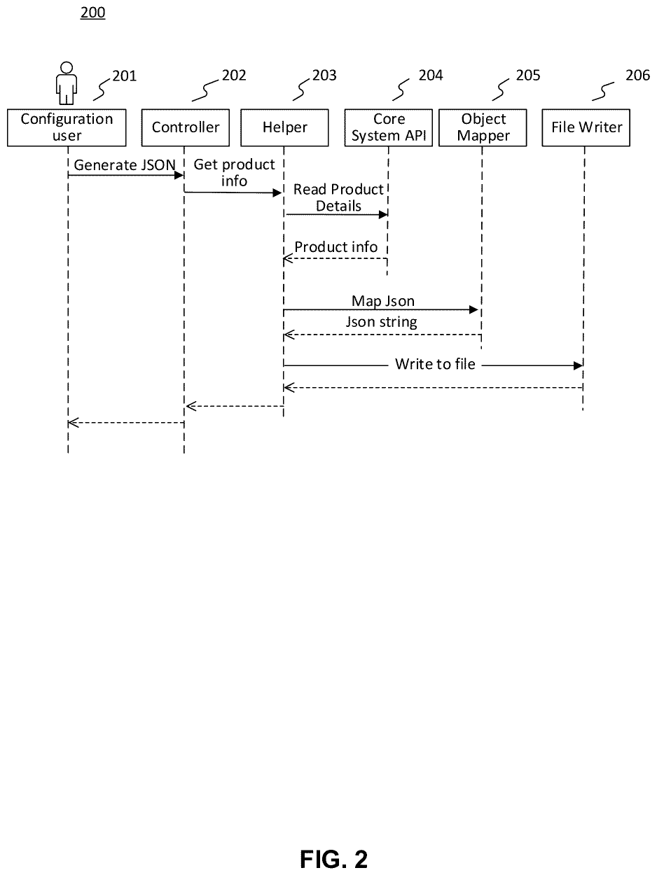

Reference is now made to FIG. 2, which illustrates a product information retrieval routine 200, consistent with embodiments of the present disclosure. According to some embodiments, product information retrieval routine 200 may implement steps 102 through 106 of CaC version control routine 100, as described above with respect to FIG. 1. According to some embodiments, in product information retrieval routine 200, the configuration user 201 may initiate a request to retrieve the product details. According to some embodiments, the configuration user may initiate the request to the controller 202. The controller 202 may initiate a function with a helper 203 to retrieve product configuration information. The helper 203 may initiate an internal call to the core system API 204 to read the product configuration details. The core system API 204 may return the product configuration details to the helper 203. The helper 203 may utilize an object mapper 205 to map the product configuration details to a JSON. The object mapper may return the product configuration details to the helper 203 as a JSON string. The helper may initiate the file writer 206 to write the JSON string to a file. The file writer 206 may return a file containing the product configuration details as a JSON string to the helper. The helper 203 may pass the file to the controller 202. The controller 202 may deliver the file to the configuration user 201.

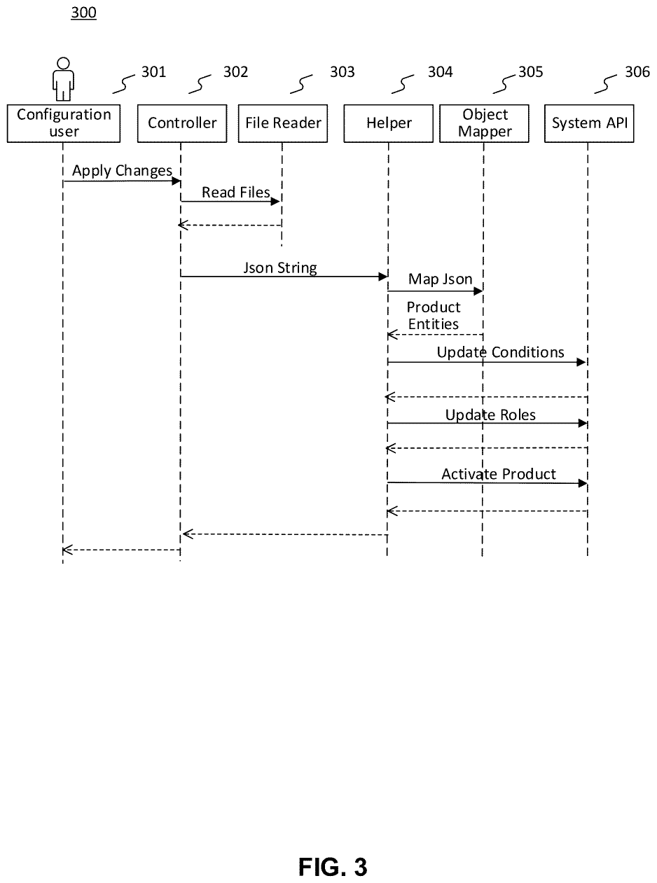

Reference is now made to FIG. 3, which illustrates a configuration application routine 300, consistent with embodiments of the present disclosure. According to some embodiments, configuration application routine 300 may implement step 108 of CaC version control routine 100, as described above with respect to FIG. 1. According to some embodiments, configuration application routine 300 may utilize the JSON file generated by configuration application routine 300. Upon executing configuration application routine 300, a configuration system may create or update the product in the target system to exactly match the configurations as per the JSON entries. This process may involve multiple invocations to different APIs of the core product.

According to some embodiments, in configuration application routine 300, the configuration user 301 may apply the changes to the JSON file to the controller 302. The controller 302 may initiate a function with a file reader 303 to read the files and pass the read files back to the controller 302. The controller 302 may initiate a function with a helper 304 to map the changed JSON file. The helper 304 may utilize an object mapper to map the product configuration details of the changed JSON files to product entities. The helper 304 may send the updated conditions to the system API 306. The helper 304 may send the updated roles to the system API 306. The helper 304 may activate the product through the system API 306. The helper 304 may pass the activated product to the controller 302. The controller may deliver the activated product to the configuration user 301.

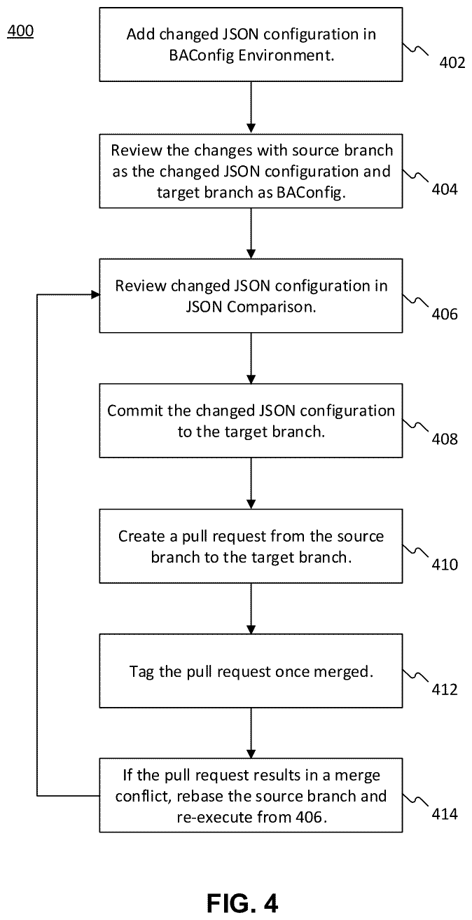

Reference is now made to FIG. 4, which illustrates CaC version control application routine 400, consistent with embodiments of the present disclosure. According to some embodiments, CaC version control application routine 400 may implement step 110 of CaC version control routine 100, as described above with respect to FIG. 1.

CaC version control application routine 400 may include step 402, in which the JSON configuration may be added in the BAConfig environment.

CaC version control application routine 400 may include step 404, in which the changes to the JSON configuration are reviewed. According to some embodiments, a branch is a separate line of development. Branching may enable separate developers to work on different features or bug fixes independently, without affecting the main project codebase. The source branch may refer to the branch that contains the changes or new features to the JSON configuration to be integrated into another branch. The target branch may refer to the branch into which the changes are merged. According to some embodiments, the changes may be reviewed with the source branch as the changed JSON configurations and the target branch as the BAConfig.

As described herein, the BAConfig environment may operate as a centralized and authoritative store of the product's configuration state, against which proposed configuration changes may be initially generated, reviewed, and validated. In some embodiments, the configuration user may add one or more changed JSON configurations to the BAConfig environment, after which the system may enable comparison and/or review between the changed configuration and the baseline configuration maintained within BAConfig. The BAConfig environment may further serve as the source for identifying configuration deltas, generating JSON difference views, and initiating downstream version-control operations such as committing changes, instantiating pull requests, and promoting validated configurations to subsequent development environments.

CaC version control application routine 400 may include step 406, in which changed JSON configurations are compared in the JSON Comparison.

CaC version control application routine 400 may include step 408, in which the changed JSON configurations are committed to the target branch.

CaC version control application routine 400 may include step 410, in which a pull request is created to merge the source branch into the target branch.

CaC version control application routine 400 may include step 412, in which a tag is created once the pull request is merged.

CaC version control application routine 400 may include step 414, which checks for a merge conflict. In the case of a merge conflict, the source branch may be rebased from the Develop branch. Following the CaC version control application routine 400 may be re-executed from step 406.

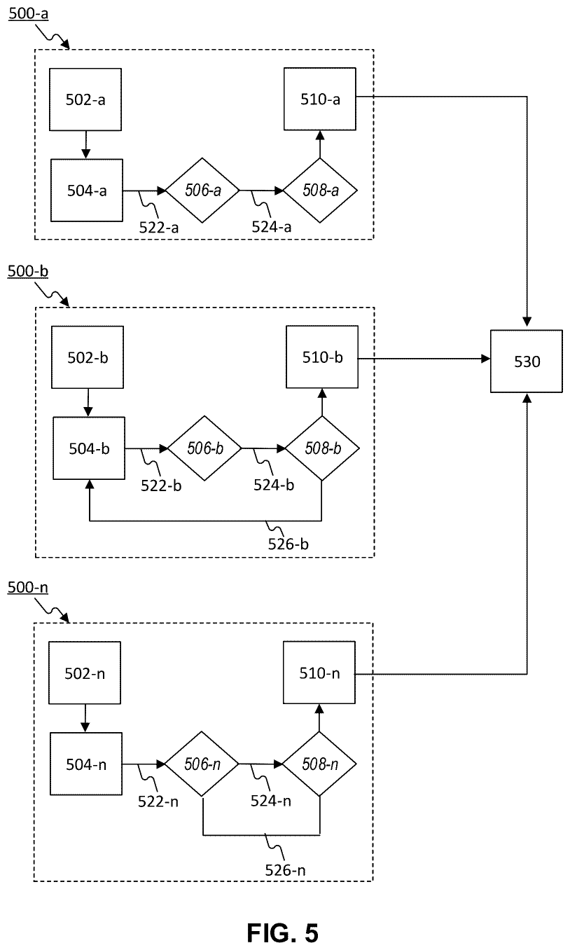

Reference is now made to FIG. 5, which illustrates parallel CaC version control application routine, consistent with embodiments of the present disclosure. Parallel CaC version control application routine may include any number of CaC version control application routines 500-a, 500-b, through 500-n, where n is any integer. According to some embodiments, parallel CaC version control application routine 500-a through 500-n may implement parallel execution of step 110 of CaC version control routine 100, as described above with respect to FIG. 1.

According to some embodiments, the configuration user may implement changes to a first JSON configuration within an administrative environment 502-a. For example, the configuration user may add or change a condition within the JSON configuration. The configuration may then approve the change to the product.

According to some embodiments, the changed JSON configuration may pass to the CaC version control 504-a. CaC version control 504-a may review the changed JSON configuration, commit the changes, and create a pull request to the source branch. The changed JSON configuration may pass as changed condition 522-a to merged branch 506-a. The merged condition 524-a may be implemented in the develop environment 508-a. The changed JSON configuration may be implemented into the product as a snapshot 510-a from develop environment 508-a. The snapshot 510-a is then promoted to develop branch 530. As described herein, a snapshot may refer to the most recent state of the respective branch upon merging. The snapshot may allow users to apply the latest configuration to lower environments (e.g., the develop branch, dev-QA, etc.), and may validate changes before moving to upstream environments.

According to some embodiments, the changed JSON configuration may pass to the CaC version control 504-b, which contains the same procedure as described with respect to CaC version control 504-a with the addition of rebasing 526-b the merged branch 506-b from the develop environment 508-b.

As described herein, in some embodiments, rebasing may refer to the process of moving and/or applying a sequence of commits from one branch (e.g., the source branch) to another branch (e.g., the target branch). In yet another embodiment, rebasing may refer to the movement of a branch to sit on top of the most recent version of another branch, and/or shifting one or more commits to be placed above a newest commit of the target branch.

In some embodiments, a pull request may be a method in version-controlled systems (e.g., GitHub, GitLab, BitBucket, etc.) where a user and/or developer may propose changes from a source branch to a target branch. The pull request may function as a as a controlled checkpoint that may govern how configuration changes move through the sequence of environments (e.g., BAConfig, Dev-QA, Milestone, Pre-Production, Production) in the CaC workflow.

In some embodiments, a merge conflict may occur when two different sets of changes modify the same part of a file, and the version-control system cannot automatically decide which version is correct.

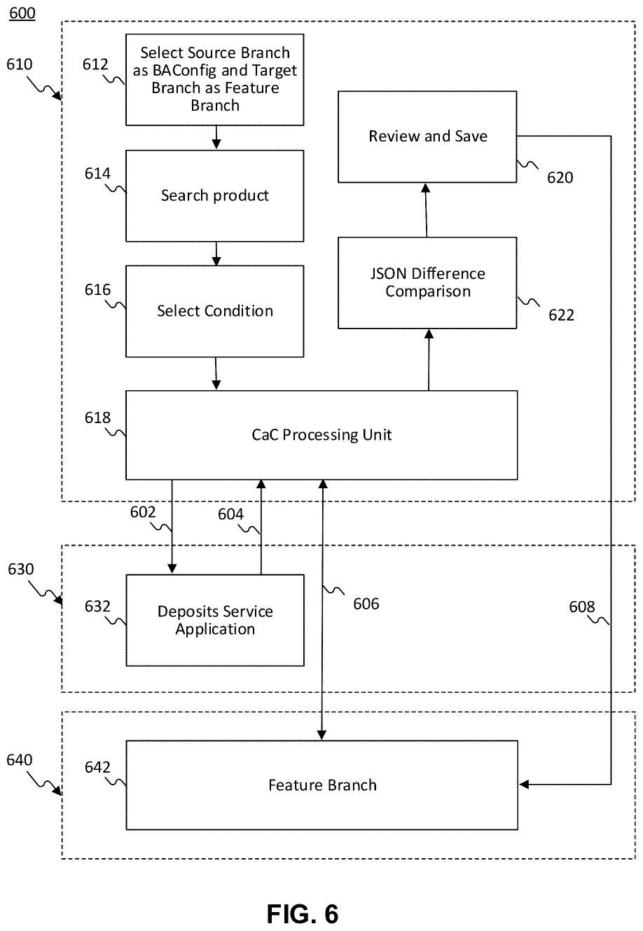

Reference is now made to FIG. 6, which illustrates configuration comparison routine 600, consistent with embodiments of the present disclosure. According to some embodiments, configuration comparison routine 600 may implement step 406 of CaC version control application routine 400, as described above with respect to FIG. 4. configuration comparison routine 600 may be used by a configuration user to review the configurations prior to promoting them. JSON difference compare user interface (“UI”) 622 may allow a configuration user to review the configuration changes. JSON difference compare UI 622 may allow a configuration user to validate the configuration changes.

In some embodiments, comparison routine 600 may operate as a core analytical module for identifying and presenting differences between one or more versions of JSON configurations. As described with respect to FIG. 6, comparison routine 600 may be invoked during the CaC workflow whenever a configuration user selects a source configuration and a target configuration for review. In particular, FIG. 6 illustrates that the user may select BAConfig as the source branch and a Feature Branch as the target branch, after which routine 600 may performs an analysis of the JSON configuration objects, which may reveal modifications made between versions.

According to some embodiments, configuration comparison routine 600 may comprise CaC tool 610, BAConfig environment 630, and feature branch environment 640. The CaC tool 610 may include a routine which passes conditions to CaC processing unit 618. Within the CaC tool 610, a configuration user may select the source branch as BAConfig and the target branch as the feature branch in step 612. The configuration user may search for the product in step 614. The configuration user may select the condition they wish to change in step 616. The CaC processing unit 618 may interface with a JSON difference compare UI 622.

One or more users may interact with JSON difference compare UI 622 comprising one or more computing devices by using a display, keyboard, mouse, microphone, touchpad, camera, sensor (e.g., touch sensor) and other input/output devices, via typed text, touch, voice, movement, computer vision, gestures, and/or other forms of input/output. An input/output device may be removable (e.g., a connectable mouse or keyboard) or may be an integral part of the computing device (e.g., a touchscreen, a built-in microphone). JSON difference compare UI 622 may support interaction between an embodiment and one or more users. JSON difference compare UI 622 may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad.

According to some embodiments, CaC processing unit 618 may also interface with the deposits service app 632 within the BAConfig environment 630. CaC processing unit 618 may send API conditions 602 to the deposits service application 632. Deposits service application 632 may send a single JSON configuration 604 to the CaC processing unity 618. CaC processing unit 618 may pass the single JSON configuration 606 to the feature branch 642 for verification. Feature branch 642 within the feature branch environment may return the verified single JSON configuration 606 to the CaC processing unit 618.

CaC processing unit 618 may provide the changed conditions and the single JSON configuration 606 to the JSON difference compare UI 622. Within the JSON difference compare UI 622, a configuration user may review the differences between the changed conditions and the single JSON configuration 606. The configuration user may then review and save the changes. The changed JSON configurations 608 may be promoted to the feature branch 642 within the feature branch environment 640.

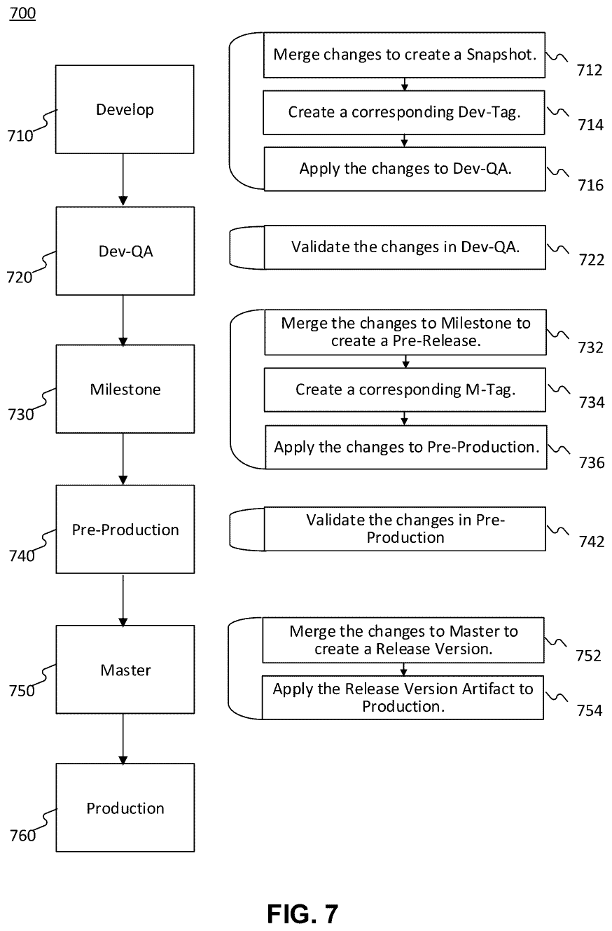

Reference is now made to FIG. 7, which illustrates version-controlled configuration promotion routine 700, consistent with embodiments of the present disclosure. According to some embodiments, version-controlled configuration promotion routine 700 may implement step 112 of CaC version control routine 100 for normal project and enhancement changes.

According to some embodiments, version-controlled configuration promotion routine 700 may comprise develop branch 710, development quality assurance (“dev-QA”) branch 720, milestone branch 730, pre-production branch 740, master branch 750, and production branch 760. The environments may form a hierarchy, where each branch represents a different version of the product running at different stages in the development cycle.

According to some embodiments, within develop branch 710, the JSON configuration changes are merged to develop branch 710 to create a snapshot in step 712. In step 714, a dev-tag is created to correspond to the configuration changes. In step 716, the changes are applied to the dev-QA branch using an applier, for example the CaC version control application routine 400 as described with respect to FIG. 4.

According to some embodiments, within dev-QA branch 720, the JSON configuration changes are validated. For example, JSON configuration changes may be validated using configuration comparison routine 600, as described above with respect to FIG. 6. Once the JSON configuration changes are validated in step 722 in the dev-QA branch 720, the JSON configuration changes may be moved to the milestone branch 730 for testing in pre-production. The JSON configuration changes may be moved from the tagged version within the dev-QA branch 720 to the milestone branch 730.

According to some embodiments, once the JSON configuration changes are merged to the milestone branch 730, a pre-release version is created in step 732. In step 734, an m-tag is created to correspond to the JSON configuration changes. In step 736, the changes are applied to the pre-production branch 740 using an applier, for example the CaC version control application routine 400 as described with respect to FIG. 4.

According to some embodiments, within pre-production branch 740, the JSON configuration changes may be validated. For example, JSON configuration changes may be validated using configuration comparison routine 600, as described above with respect to FIG. 6. Once the JSON configuration changes are validated in step 742 in the pre-production branch 740, the JSON configuration changes may be moved to from the m-tag version to the master branch 750.

According to some embodiments, once the JSON configuration changes are merged in master branch 750, a release version may be created in step 752. In step 754, the release version artifact may be applied to the production branch 760 using an applier, for example the CaC version control application routine 400 as described with respect to FIG. 4.

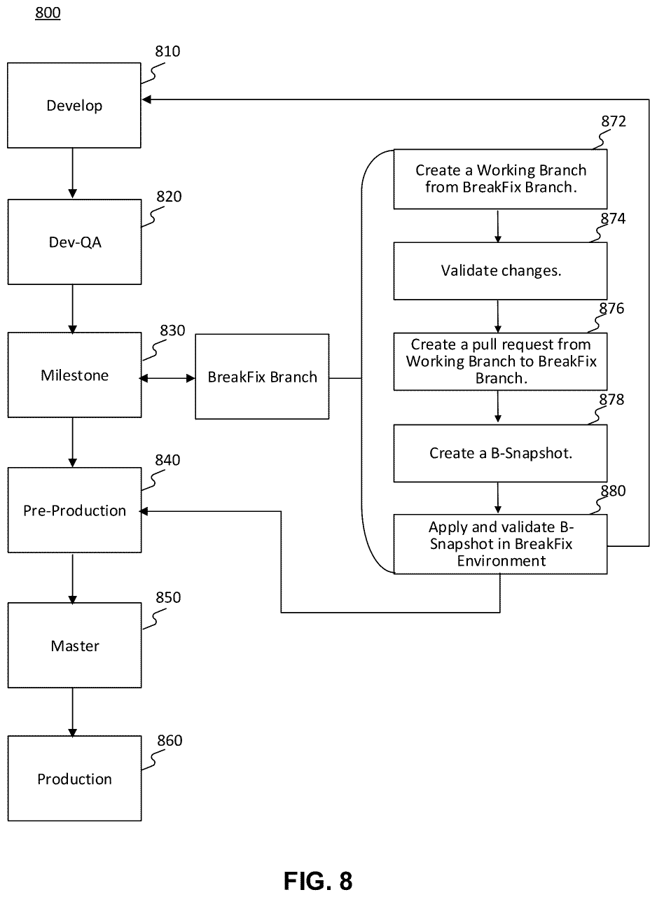

Reference is now made to FIG. 8, which illustrates parallel version-controlled configuration promotion routine 800, consistent with embodiments of the present disclosure. According to some embodiments, parallel version-controlled configuration promotion routine 800 may implement step 112 of CaC version control routine 100 for normal project and enhancement changes, as described above with respect to FIG. 1. According to some embodiments, parallel version-controlled configuration promotion routine 800 may implement step 112 of CaC version control routine 100 in scenarios when a critical configuration is moved to production in a short time. According to some embodiments, parallel version-controlled configuration promotion routine 800 may implement step 112 of CaC version control routine 100 in scenarios when one configuration change is behind the rest of the development and one configuration change is required to be promoted to production. According to some embodiments, parallel version-controlled configuration promotion routine 800 may implement step 112 of CaC version control routine 100 in scenarios for “BreakFix” changes.

According to some embodiments, parallel version-controlled configuration promotion routine 800 may comprise develop branch 810, development quality assurance (“dev-QA”) branch 820, milestone branch 830, pre-production branch 840, master branch 850, production branch 860; and BreakFix branch 870. The environments may form a hierarchy, where each branch represents a different version of the product running at different stages in the development cycle. BreakFix branch 870 may run parallel to milestone branch 830.

According to some embodiments, the development hierarchy from the develop branch 810 through production branch 860 may comprise the corresponding routine steps as version-controlled configuration promotion routine 700 from development branch 710 through production branch 760, as described above with respect to FIG. 7.

According to some embodiments, the BreakFix branch 870 may be the source for development of JSON configuration changes in the above-described scenarios when a JSON configuration change is urgent or otherwise behind the rest of production development. According to some embodiments, the BreakFix branch 870 may be in sync with milestone branch 830 and may be periodically rebased from milestone branch 830.

According to some embodiments, individual production support teams can create additional development branches (not pictured) from the BreakFix branch 870 in step 872.

According to some embodiments, within BreakFix branch 870, the JSON configuration changes may be validated in step 874. For example, JSON configuration changes may be validated using configuration comparison routine 600, as described above with respect to FIG. 6. Once the JSON configuration changes are validated in step 874, a pull request may be generated from the working branch to the BreakFix branch 870 in step 876. In step 878, BreakFix may create a B-Snapshot. The B-Snapshot may be applied to the BreakFix branch 870 environment and may be validated in step 880. For example, configuration changes may be validated using configuration comparison routine 600, as described above with respect to FIG. 6. The B-Snapshot may be applied to the pre-production branch 840 using an applier, for example the CaC version control application routine 400 as described with respect to FIG. 4.

According to some embodiments, the validated JSON configuration changes may be implemented following the promotion hierarchy from pre-production branch 840 to master branch 850, to production branch 860, for example as described above with respect to FIG. 7. According to some embodiments, the validated configuration changes may be implemented in the develop branch 810 such that the develop branch 810 stays current with configuration changes from the BreakFix Branch 870.

According to some embodiments, the BreakFix branch 870 may be adapted to handle merge issues. For example, in operation, a JSON configuration change being made in a working branch from the BreakFix branch 870 may be the same JSON configuration being worked on by other teams in the develop branch 810. According to some embodiments, the JSON configuration may be segregated into a granular level and have individual JSONs for the divided JSON configuration. According to some embodiments, segregating the JSON configuration may reduce JSON management issues when the JSON configuration is large. According to some embodiments, segregating the JSON configuration may reduce the burden of both serialization and deserialization. According to some embodiments, segregating the JSON configuration may make JSON comparison less difficult, for example when the JSON configuration comprises a large amount of data or information. According to some embodiments, segregating the JSON configuration may reduce the need for separate comparator logic because segregation may make the comparison logic the same between segments as a folder-to-folder comparison. According to some embodiments, segregating the JSON configuration may reduce the potential chance of merge conflicts.

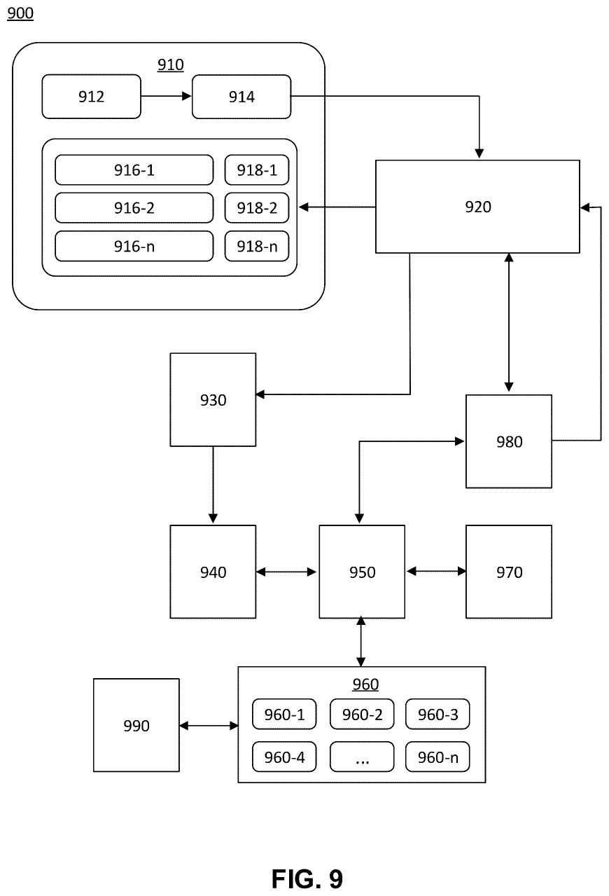

Reference is now made to FIG. 9, which illustrates configuration change applier routine 900, consistent with embodiments of the present disclosure. According to some embodiments, version-controlled configuration promotion routine 900 may implement step 112 of CaC version control routine 100, as described above with respect to FIG. 1. According to some embodiments, version-controlled configuration promotion routine 900 may implement step 112 of CaC version control routine 100.

According to some embodiments, configuration change applier routine 900 may comprise CaC UI 910, change table 920, scheduled JSON generator 930, file system 940, comparator 950, product mapper 960, artifactory 970, scheduled product change applier 980, and product change applier API 990.

According to some embodiments, configuration change applier routine 900 may utilize a series of APIs. Configuration change applier routine 900 may reduce the risk of asynchronicity in the development system by utilizing scheduled JSON generator 930 and scheduled product change applier 980 to apply configuration changes.

In some embodiments, types of appliers may comprise a product change applier and/or a pricing change applier. may take the version-controlled JSON configuration artifact (e.g., a snapshot or prerelease) and apply product-level configuration changes to the target system environment. Pricing change applier may be responsible for taking a version-controlled pricing configuration artifact (for example, FTBPRICING-2.3-SNAPSHOT) and applying pricing-related configuration changes to the target system environment. Pricing change applier may perform operations similar to the Product Change Applier, but focused on pricing constructs (pricing rules, pricing relationships, fees, earning types, balance-related pricing parameters, transaction-type pricing, etc.).

According to some embodiments, CaC UI 910 may allow the configuration user to select the type of applier to use. For example, the configuration user may select the product or portion of the product to which they want to apply their CaC change as a change request. For example, the configuration user may select the type of applier at applier choice 912. For example, the configuration user may select the artifact version of the change at selection 914. According to some embodiments, CaC UI 910 may comprise options 916-1, 916-2, through 916-n, where n is any integer, of products or portions of a product from which the configuration user may select. Corresponding progress indicators 918-1, 918-2, through 918-n may indicate where in the change process the corresponding product or portion of a product 916-1, 916-2, through 916-nare. For example, progress indicators 918-1, 918-2, 918-n may display “in progress,” or “completed.” Once the choice is submitted through the CaC UI 910, the choice may be saved in change table 920 with an entry status as “in progress.”

According to some embodiments, scheduled JSON generator 930 may operate a background spring scheduler. The scheduled JSON generator 930 may generate the most up-to-date JSON configurations from the working environment and keep the most up-to-date JSON configurations in the file system 940. The scheduled JSON generator 930 may look up a JSON configuration change applier database to see which appliers have been requested for and which versions. Based on that information, scheduled JSON generator 930 may download the corresponding artifact from artifactory 970 to prepare for subsequent application. File system 940 may pass the most up-to-date JSON configuration to comparator 950.

According to some embodiments, scheduled product change applier 980 may operate a background spring scheduler. Scheduled product change applier 980 may continuously poll the change table 920 to check for pending change requests. Scheduled product change applier 980 may invoke the workflow which initiate a series of API calls required to apply the configuration changes. According to some embodiments, when a change request is pending, scheduled product change applier 980 may call a corresponding applier, for example, CaC version control application routine 400, as described above with respect to FIG. 4.

According to some embodiments, scheduled product change applier 980 may call comparator 950 to implement a folder to folder to comparison between the selected type of change request, the up-to-date JSON configuration store in file system 940, or configurations stored in artifactory 970. Comparator 950 may prepare a list of changes based on the comparison.

According to some embodiments, comparator 950 may call a responding mappers in product mapper 960. Product mapper 960 may comprise a plurality of configuration mappers 960-1 through 960-n, where n can be any integer, where each of the configuration mappers corresponds to a mapping routine for a JSON configuration. By way of example, product mapper 960 may include, but is not limited to a condition mapper, details mapper, currency mapper, services mapper, relationships mapper, balance type mapper, and/or earning type mapper, which may be referenced by 960-1 through 960-n. For instance, condition types may be referenced by condition mapper, and currency types may be referenced as currency mapper. Product mapper 960 may call the product change applier API 990. According to some embodiments, product change applier 990 may implement CaC version control application routine 400, as described above with respect to FIG. 4. According to some embodiments, once the product change applier API 990 process is completed, the response status stored in the change table 920 may be “completed.” Following, the corresponding progress indicators 918-1, 918-2, through 918-n may indicate that change process for the corresponding product or portion of a product 916-1, 916-2, through 916-nis completed.

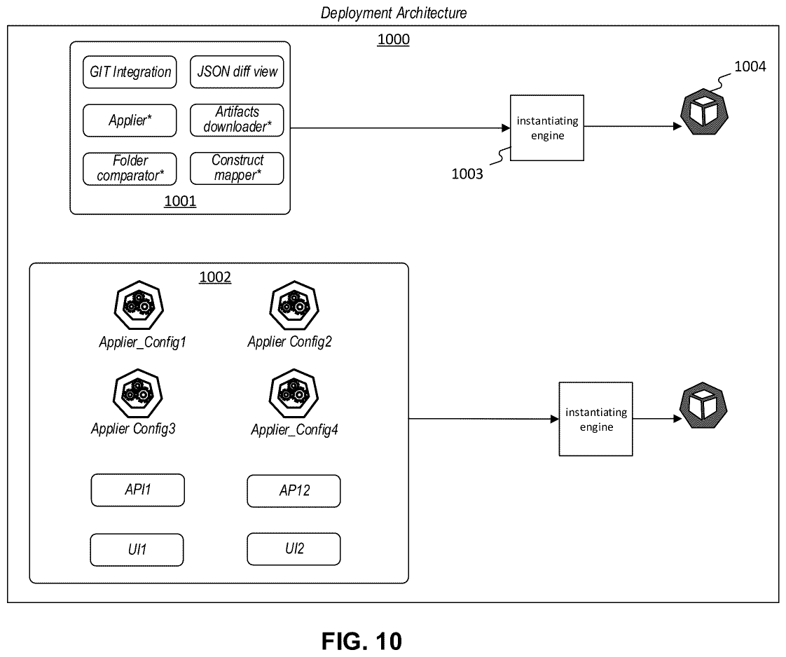

Reference is now made to FIG. 10, which illustrates configuration change deployment architecture 1000, consistent with embodiments of the present disclosure. According to some embodiments, configuration change deployment architecture 1000 may include GIT integration; a JSON comparison viewer, for example, utilizing configuration comparison routine 600, as described above with respect to FIG. 6; an applier, for example CaC control application routine 400, as described above with respect to FIG. 4; an artifactor downloader, for example, scheduled JSON generator 930 and artifactory 970, as described above with respect to FIG. 9; a folder comparator, for example, comparator 950, as described above with respect to FIG. 9; a construct mapper, for product mapper 960, as described above with respect to FIG. 9; a docker; and a CaC administrative UI.

In some embodiments, deployment architecture 1000 may be provided to orchestrate execution of CaC operations across multiple system components. As illustrated, deployment architecture 1000 may include a core configuration-management subsystem 1001 comprising, but not limited to, GIT integration functionality, a JSON diff viewer, an applier engine, an artifacts downloader, a folder comparator, and a construct mapper. Core subsystem 1001 may be configured to receive version-controlled JSON configuration artifacts, compare such artifacts against baseline or target configurations, and determine the construct-level changes that may be applied. Subsystem 1001 may communicate the resulting configuration artifacts or instructions to an instantiating engine 1003, which may instantiate executable units or deployment packages used to promote configuration changes. Instantiating engine 1003 may generate an output artifact 1004 corresponding to a deployable configuration bundle for the target environment. Instantiating engine may a comprise a Docker, container runtime interface (CRI)-compatible tools like containerd and CRI-O, Podman, LXD, or the like.

In some embodiments, deployment architecture 1000 may further comprise an applier-execution environment 1002 including a plurality of applier configurations (e.g., Applier_Config1, Applier_Config2, Applier_Config3, Applier_Config4). Each applier configuration may be associated with one or more system APIs (e.g., API1, API2) and user interfaces (e.g., UI1, UI2) that enable the configuration user to submit JSON-based configuration changes, review construct-level differences, and/or invoke downstream application workflows. The applier configurations in environment 1002 may operate in parallel to process different configuration domains, such as conditions, roles, currencies, or service attributes, and translate JSON entries into corresponding product-entity updates. In some embodiments, the outputs generated by applier configurations 1002 may likewise be provided to instantiating engine 1003 configured to generate a deployable configuration artifact for use in downstream CaC promotion stages.

In some embodiments, deployment architecture 1000 may implement a two-stage artifact-processing pipeline in which (i) core subsystem 1001 performs JSON comparison, folder-level diffing, artifact retrieval, and construct-type identification, and (ii) applier configurations 1002 perform entity-level mapping and application of JSON configuration changes through associated APIs. The outputs of both stages may be transmitted to an instantiating engine 1003, which may package, instantiate, or otherwise prepare a final configuration artifact 1004. The instantiating engine may be configured to apply the package to BAConfig, Develop, Dev-QA, Milestone, or Production environments according to the promotion method described in the CaC version-control routine. In this manner, the deployment architecture provides an integrated framework for retrieving JSON constructs, comparing configuration states, applying changes across multiple appliers, and generating environment-ready configuration artifacts.

According to some embodiments, configuration change deployment architecture 1000 may include appliers for a plurality of JSON configurations, for example CaC control application routine 400, as described above with respect to FIG. 4; a plurality of APIs; and a plurality of UIs.

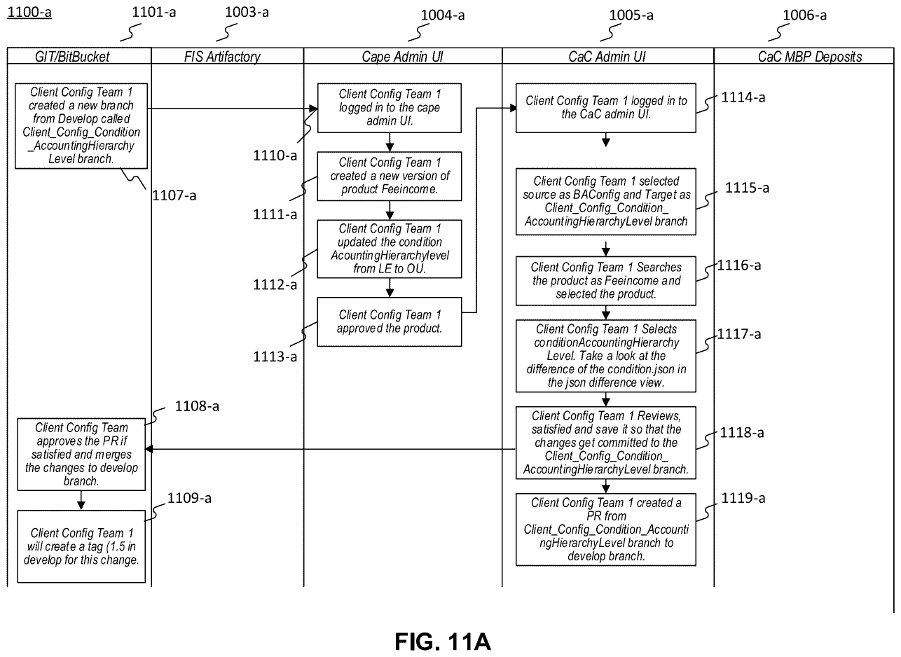

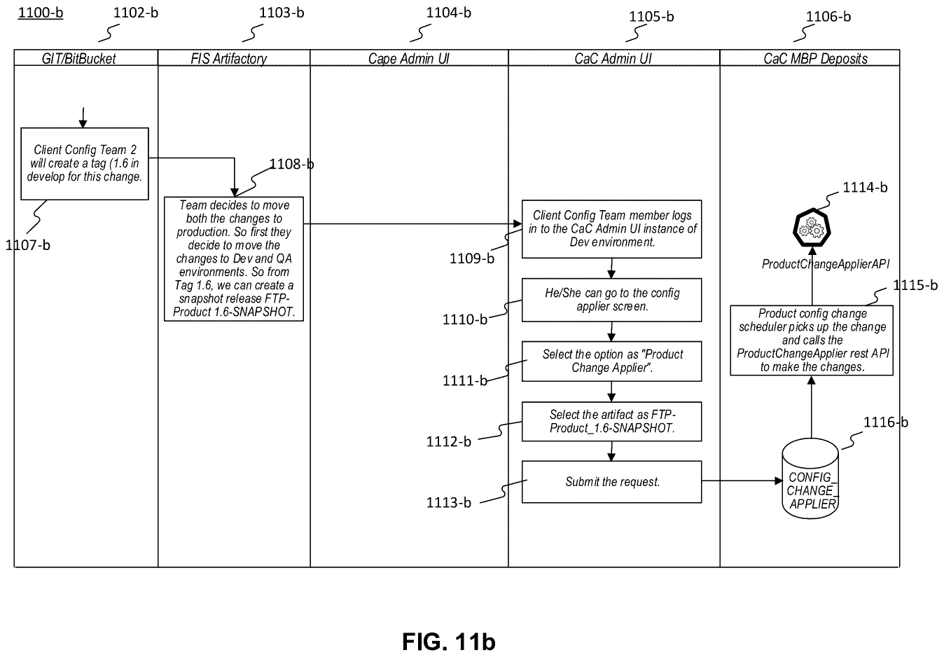

Reference is now made to FIG. 11A, which illustrates a first portion of CaC version control business process flow 1100-a, consistent with embodiments of the present disclosure. According to some embodiments, FIG. 11A may represent a first configuration user implementing JSON configuration changes in parallel with other teams.

In some embodiments, CaC version control business process flow 1100-a may be implemented to manage product-level configuration changes across multiple system components. As illustrated in FIG. 11A, the workflow may begin when a configuration team creates a new version-control branch in a GIT- or BitBucket-based repository 1101-a. For example, Client Config Team 1 may create a new branch 1107-a named Client_Config_Condition_AccountingHierarchyLevel from a develop branch for purposes of isolating a configuration change. Upon branch creation, a team member may log into a product administration interface 1110-a, within the Cape Admin UI 1004-a, and generate a new version of the target product in step 1111-a. The team member may update one or more product conditions 1112-a, such as modifying an AccountingHierarchyLevel parameter from a first value (e.g., LE) to a second value (e.g., OU), and subsequently approve the updated product configuration in step 1113-a for further processing.

In some embodiments, the CaC workflow may further include operations performed within a CaC Administration interface 1005-a. As shown in FIG. 11A, upon approving the product in step 1113-a, a configuration user may log into the CaC Admin UI 1114-a and select a source environment 1115-a, such as BAConfig, and a target branch, such as the newly created Client_Config_Condition_AccountingHierarchyLevel branch. The configuration user may then search for the updated product (e.g., Feeincome) 1116-a and select the construct corresponding to the modified condition. The CaC Admin UI may display a JSON difference view illustrating changes between the baseline configuration and the modified configuration in step 1117-a. In step 1118-a, the configuration user may review the JSON diff, confirm that the modifications accurately reflect the intended updates, and save the changes so that they are committed into the target branch. In some embodiments, the system may automatically write the updated JSON artifacts into version control upon user confirmation.

In some embodiments, once the JSON changes have been committed to the branch, the configuration user may initiate a pull request from a newly generated branch to the develop branch 1119-a. In other embodiments illustrated in FIG. 11A, the pull request may be reviewed by Client Config Team 1 through the GIT/BitBucket interface 1100-a. If the team approves the proposed changes, the pull request may be merged into the develop branch 1108-a. Upon successful merge, the system may generate a version tag (e.g., 1.5) corresponding to the merged configuration state, which may be pushed to an artifact repository such as FIS Artifactory 1101-a for subsequent application and promotion through downstream environments. This tag may uniquely identify the configuration snapshot associated with the approved changes, enabling traceability and downstream deployment through the CaC MBP Deposits system 1006-a.

Reference is now made to FIG. 11B, which illustrates a second portion of CaC version control business process flow 1100-b, consistent with embodiments of the present disclosure. According to some embodiments, FIG. 11A may represent a second configuration user implementing JSON configuration changes in parallel with other teams.

In some embodiments, and as illustrated in FIG. 11B, once the configuration changes have been merged into the develop branch, a configuration team member may generate a corresponding version tag in the version-control system 1100-b. For example, Client Config Team 2 may create a tag (e.g., 1.6) that uniquely identifies the configuration state committed to the develop branch 1107-b. In some embodiments, the tagged version may be published to an artifact repository, such as FIS Artifactory 1103-b, where it may be used as the basis for downstream configuration promotion. The configuration team may determine that the approved changes must be moved through Dev and QA environments prior to production deployment. Accordingly, as shown in operation 1108-b, the system may generate a snapshot artifact (e.g., FTP-Product_1.6-SNAPSHOT) from the version tag to support the validation.

In some embodiments, and as further depicted in FIG. 11B, a configuration team member may log in 1109-b to a CaC Admin UI 1105-b corresponding to a selected environment. Upon authentication, the user may navigate to a configuration-applier interface 1110-b, where the user may select an applier type. In some embodiments, the user may choose a Product Change Applier option 1111-b, which is configured to apply full product-level configuration changes derived from the JSON artifact. The user may then select the snapshot artifact corresponding to the previously created tag, such as FTP-Product_1.6-SNAPSHOT 1112-b. Once the appropriate artifact is selected, the user may submit the request 1113-b, initiating a configuration-application workflow.

In some embodiments, the submission of a Product Change Applier request may enqueue the request in a configuration-change scheduling component 1116-b. As depicted in FIG. 11B, the product-config scheduler may retrieve the queued job within CaC MBP Deoposits 1106-b and invoke a corresponding rest API of a Product Change Applier service 1115-b. The Product Change Applier API may read the selected snapshot artifact, extract the underlying JSON configuration content, and apply the associated configuration changes to the target system environment. In some embodiments, the applier may perform multiple API calls, including, but not limited to, updating product constructs, setting condition or role values, and activating the updated product configuration. Following completion of the workflow, the Product Change Applier system 1116-b may record the applied changes and expose outcome status information to the CaC MBP Deposits system 1106-b.

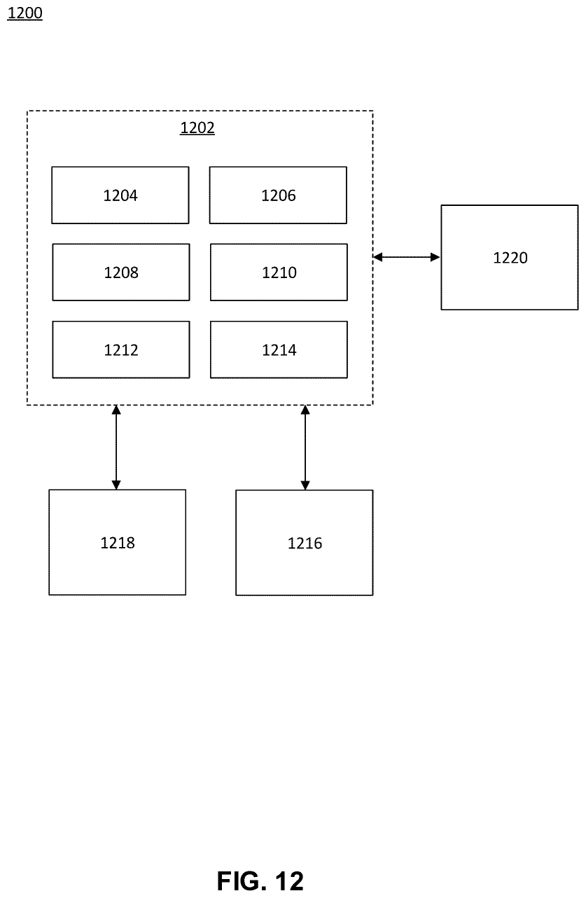

Reference is now made to FIG. 12, which illustrates an exemplary operating environment for implementing various aspects of this disclosure. As illustrated in FIG. 12, an exemplary operating environment 1200 may include a computing device 1202 (e.g., a general-purpose computing device) in the form of a computer. Components of the computing device 1202 may include, but are not limited to, various hardware components, such as one or more processors 1206, data storage 1208, a system memory 1204, other hardware 1210, and a system bus (not shown) that couples (e.g., communicably couples, physically couples, and/or electrically couples) various system components such that the components may transmit data to and from one another.

With further reference to FIG. 12, an operating environment 1200 for an exemplary embodiment includes at least one computing device 1202. The computing device 1202 may be a uniprocessor or multiprocessor computing device. An operating environment 1200 may include one or more computing devices (e.g., multiple computing devices 1202) in a given computer system, which may be clustered, part of a local area network (LAN), part of a wide area network (WAN), client-server networked, peer-to-peer networked within a cloud, or otherwise communicably linked. A computer system may include an individual machine or a group of cooperating machines. A given computing device 1202 may be configured for end-users, e.g., with applications, for administrators, as a server, as a distributed processing node, as a special-purpose processing device, or otherwise configured to train machine learning models and/or use machine learning models.

One or more users may interact with the computer system comprising one or more computing devices 1202 by using a display, keyboard, mouse, microphone, touchpad, camera, sensor (e.g., touch sensor) and other input/output devices 1218, via typed text, touch, voice, movement, computer vision, gestures, and/or other forms of input/output. An input/output device 1218 may be removable (e.g., a connectable mouse or keyboard) or may be an integral part of the computing device 1202 (e.g., a touchscreen, a built-in microphone). A user interface 1212 may support interaction between an embodiment and one or more users. A user interface 1212 may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad.

Computing device 1202 includes at least one logical processor 1206. The at least one logical processor 1206 may include circuitry and transistors configured to execute instructions from memory (e.g., memory 1204). For example, the at least one logical processor 1206 may include one or more central processing units (CPUs), arithmetic logic units (ALUs), Floating Point Units (FPUs), and/or Graphics Processing Units (GPUs). The computing device 1202, like other suitable devices, also includes one or more computer-readable storage media, which may include, but are not limited to, memory 1204 and data storage 1208. In some embodiments, memory 1204 and data storage 1208 may be part a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 1220 such as a portable (i.e., external) hard drive, compact disc (CD), Digital Versatile Disc (DVD), memory stick, or other removable non-volatile memory medium may become functionally a technological part of the computer system when inserted or otherwise installed with respect to one or more computing devices 1202, making its content accessible for interaction with and use by processor(s) 1206. The removable configured medium 1220 is an example of a computer-readable storage medium. Some other examples of computer-readable storage media include built-in random access memory (RAM), read-only memory (ROM), hard disks, and other memory storage devices which are not readily removable by users (e.g., memory 1204). In some embodiments, configured medium 1220 may be non-transitory.

The configured medium 1220 may be configured with instructions (e.g., binary instructions) that are executable by a processor 1206; “executable” is used in a broad sense herein to include machine code, interpretable code, bytecode, compiled code, and/or any other code that is configured to run on a machine, including a physical machine or a virtualized computing instance (e.g., a virtual machine or a container). The configured medium 1220 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 1210 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In some embodiments, the system includes multiple computing devices 1202 connected by network(s) 1216. Networking interface equipment can provide access to network(s) 1216, using components (which may be part of a network interface 1214) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches.

The computing device 1202 may operate in a networked or cloud-computing environment using logical connections to one or more remote devices (e.g., using network(s) 1216), such as a remote computer (e.g., another computing device 1202). The remote computer may include one or more of a personal computer, a server, a router, a network PC, or a peer device or other common network node, and may include any or all of the elements described above relative to the computer. The logical connections may include one or more LANs, WANs, and/or the Internet.

Computing device 1202 typically may include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for a machine learning model, and/or a machine learning model itself) and which can be accessed by the computer.

The data storage 1208 or system memory includes computer storage media in the form of volatile and/or nonvolatile memory such as ROM and RAM. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 1208 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

Computer-readable media may be embodied as a computer program product, such as software (e.g., including program modules) stored on non-transitory computer-readable storage media. Any combination of one or more computer-readable medium(s) may be utilized. The computer-readable medium may be a non-transitory computer-readable storage medium.

It will be apparent to those skilled in the art that various modifications and variations can be made to the environment instantiation platform. While illustrative embodiments have been described herein, the scope of the invention includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit of the invention being indicated by the following claims and their full scope of equivalents.

1. A method of version control for development of a software product, the method comprising:
generating a JavaScript object notation (JSON) for each of a plurality of entities;
generating a plurality of configurations from each JSON;
changing at least one configuration of the plurality of configurations;
applying the at least one changed configuration to one or more environments; and
promoting the at least one changed configuration to the product.

2. The method of claim 1, wherein each JSON is generated via a representational state transfer application programming interface (rest API).

3. The method of claim 1, wherein applying the at least one changed configuration further comprises:
adding the at least one changed configuration to a first environment of the one or more environments;
reviewing changes of the at least one changed configuration;
committing the at least one changed configuration to the first environment;
instantiating a pull request configured to merge the at least one changed configuration to the first environment; and
assigning a tag to the pull request upon merging the at least one changed configuration to the first environment.

4. The method of claim 3, further comprising:
determining that the pull request comprises a merge conflict; and
in response to determining that the pull request comprises a merge conflict:
operating in a first state, wherein the first state comprises rebasing the source branch and re-executing the reviewing, the committing, the instantiating, and the assigning.

5. The method of claim 3, wherein the reviewing comprises reviewing the at least one changed configuration in a comparison routine.

6. The method of claim 3, wherein the at least one changed configuration is assigned to a source branch, and the first environment is assigned to a target branch.

7. The method of claim 1, wherein each JSON is stored in a common directory of the product.

8. A system for version control for development of a product, the system comprising:
at least one processor; and
a non-transitory computer-readable medium containing instructions that, when executed by the at least one processor, cause the at least one processor to perform operations comprising:
generating a JavaScript object notation (JSON) for each of a plurality of entities in the product;
generating a plurality of configurations from each JSON;
changing at least one configuration of the plurality of configurations;
applying the at least one changed configuration to one or more environments; and
promoting the at least one changed configuration to the product.

9. The system of claim 8, further comprising a develop branch and a production branch, and wherein the operations further comprise:
merging, via the develop branch, changes in the at least one changed configuration to create a snapshot;
generating a development tag corresponding to the snapshot; and
applying the changes to a development quality assurance (dev-QA) branch.

10. The system of claim 9, wherein the dev-QA branch is configured to validate the changes and move the changes to a milestone branch, and wherein the milestone branch is configured to:
merge changes in the changed JSON configuration to generate a pre-release;
generate an M-tag corresponding to the generated pre-release; and
apply the changes to a pre-production branch.

11. The system of claim 10, wherein the pre-production branch is configured to validate the changes move the changes to a master branch; and
wherein the master branch is configured to:
merge changes in the changed JSON configuration to generate a release version; and
apply the changes to the production branch.

12. The system of claim 10, further comprising a BreakFix branch configured to run in parallel with the milestone branch.

13. The system of claim 12, wherein the BreakFix branch is configured to apply and validate a B-snapshot to the pre-production branch.

14. The system of claim 12, wherein the develop branch is updated based on the BreakFix branch.

15. The system of claim 8, wherein the operations further comprise selecting, via a configuration as code user interface (CaC UI), a type of applier from a plurality of appliers.

16. The system of claim 8, wherein the type of appliers comprises at least one of a product change applier or a pricing change applier.

17. The system of claim 8, wherein the operations further comprise:
adding the at least one changed configuration to a first environment of the one or more environments;
reviewing changes of the at least one changed configuration;
committing the at least one changed configuration to the first environment;
instantiating a pull request configured to merge the at least one changed configuration to the first environment; and
assigning a tag to the pull request upon merging the at least one changed configuration to the first environment.

18. The system of claim 8, wherein the operations further comprise generating, via a first background spring scheduler, a latest JSON from each JSON.

19. The system of claim 8, wherein generating the JavaScript object notation (JSON) for each of the plurality of entities further comprises segregating a JSON configuration into a plurality of granular JSON files, and wherein each granular JSON file in the plurality of granular JSON files corresponds to a respective entity.

20. The system of claim 19, wherein comparison of the JSON configuration is performed as a folder-to-folder comparison.
